(19) United States
(12) Patent Application Publication
(10) Pub. No.: US 2010/0195204 A1
(43) Pub. Date: Aug. 5, 2010

(54) OPTICAL FILM

(75) Inventor: Nicholas Simon Walker, Swindon (GB)

Correspondence Address: INTELLECTUAL PROPERTY / TECHNOLOGY LAW, PO BOX 14329, RESEARCH TRIANGLE PARK, NC, 27709, US

(73) Assignee: MICROSHARP CORPORATION LIMITED, Swindon (GB)

(21) Appl. No.: 12/665,985

(22) PCT Filed: Jun. 27, 2008
(86) PCT No.: PCT/GB2008/002228

§ 371 Date: Jan. 29, 2010

(30) Foreign Application Priority Data
Jun. 28, 2007 (GB) 0712605.5

(51) Int. Cl. G02B 1/11; B32B 3/30; G02B 5/00

(52) U.S. Cl. 359/507; 428/156; 428/167; 428/172; 359/652

(57) ABSTRACT

The present invention provides a nanostructure comprising a plurality of nanoridges wherein the height of each nanoridge is modulated whereby to form one or more peaks (e.g. a series of peaks) along the length of each nanoridge.

This invention relates to nanostructures having anti-reflective properties and their use in optical films. More particularly, it relates to such structures having both anti-reflective and self-cleaning properties and their use in devices which capture light, such as solar cell modules and solar concentrators.

Reflection of light from a surface reduces the efficiency of devices which seek to collect light, for example to generate electricity or heat, or for use in hydrogen production, or which capture light for transmission purposes, e.g. for transmission along light guides to illuminate the interior of a building or simply to illuminate a dark interior where there is little natural incoming light.

Solar concentrators are optical systems which focus light from a relatively wide area of direct sun illumination into a reduced area in which an energy transducer device (e.g. a photovoltaic cell) is located, thereby allowing a smaller transducer to be used and so reducing the cost of solar power systems (which are typically dominated by the price of the energy transducer). All light reflected from the surface of a transmissive light collecting device, such as a solar cell module or refracting solar concentrator, is lost and the overall light collected thereby reduced. By placing an anti-reflective coating on the outside of the light collecting surface, reflections are reduced and the efficiency of the collector thereby increased.

Dust and grime which collects on the outside of a light collecting device also reduces the efficiency of the device by reducing the transmission of the surface. Therefore, solar panels and solar collectors have to be cleaned in order to retain their efficiency over time. Even in climates with high direct solar illumination, rainfall does usually occur and this can assist in the cleaning of the outer surfaces of such devices. In addition, it is possible to operate sprinklers to effect a low cost artificial alternative to rainfall to perform such cleaning. Surfaces which are able to self-clean, removing dust and grime, under the influence of rainfall or sprinkler systems, would be particularly beneficial if present on light collecting devices.

Light reflection is a problem which can also affect the surface of displays, particularly those used to show an image which has been produced electronically, for example those found in television receivers, computer monitors, projection display systems, etc. Reflection of ambient light from the surface of the display produces distracting surface reflections or glare thereby reducing the quality of the image.

This invention provides in one aspect a substrate, for example a transparent optical film, comprising a modulated nanoridge structure which operates as an anti-reflection surface. The invention also extends to such substrates having improved anti-reflection properties, in particular to substrates which are an efficient anti-reflector of incident light (e.g. optical light) over a wide range of angles of incident light, especially at high angles of incident light (e.g. at angles greater than 60 degrees from the surface normal). Substrates in accordance with at least this aspect of the invention are particularly suitable for use on the surface of devices which capture light, such as solar cell modules and solar concentrators, and on the surface of displays in order to reduce distracting surface reflections.

In a further aspect the invention provides a substrate, e.g. a transparent optical film, comprising a modulated nanoridge structure which operates as both an anti-reflection surface and a self-cleaning surface. These substrates are particularly suitable for use on the outer surfaces of light collecting devices which need to stay clean, such as solar cells, optical concentrators and windows.

Viewed from one aspect the present invention thus provides a nanostructure comprising a plurality of nanoridges in which the height of each nanoridge is modulated whereby to form one or more peaks (e.g. a series of peaks) along the length of each nanoridge. In general, the length of each nanoridge will be far greater than its height (e.g. its maximum height). Typically the length of each nanoridge will be of the order of cm, e.g. more than 1 cm.

In order to maximise anti-reflective properties (based upon the effect of “appearing” to the light to be a surface with a graded refractive index interface) it is preferred that one or more, preferably all, dimensions of the nanostructure are less than half the wavelength of incident light. These dimensions include, in particular, the pitch and height (and also preferably the maximum height) of each nanoridge, the pitch and height of each peak provided along the length of the nanoridge structure, and the separation of adjacent nanoridges and/or peaks (in the case where adjacent nanoridges and/or peaks are non-contacting at their base). Preferably, the dimensions of the nanostructure will be sub-wavelength, more preferably less than half the wavelength of incident light, e.g. less than a quarter of the wavelength of incident light. Although incident light will encompass a broad range of wavelengths, preferably this refers to the incident light in respect of which reflections are desired to be reduced. Typically the wavelength of interest will be that in the optical range (to near IR), i.e. in the range 400 nm to 1000 nm since these are the wavelengths which photovoltaic cells are able to use to generate a current.

The precise shape and size of each nanoridge (and in turn that of the resulting peaks along its length) is not critical and it is envisaged that a wide range of different shapes and sizes may be capable of providing the desired modulation in height along each nanoridge and thus the desired anti-reflection properties. Suitable shapes and dimensions may readily be determined by those skilled in the art. For example, nanoridges and/or peaks may be angular, smooth, curved, blunt, etc., or any combination thereof. Within a given nanostructure, different nanoridges may differ in shape and/or size. Similar considerations will apply to the shape and size of different peaks along a given nanoridge and/or to different peaks on different nanoridges. In general it will, however, be preferred that each nanoridge (and its associated peaks) will be substantially identical in shape and size (at least to within the tolerance limits of the manufacturing process).

Similarly, the precise orientation and separation of the nanoridges and the separation of peaks along a particular nanoridge may vary whilst still achieving the desired effects described herein. However, it is preferable that these are regularly spaced, preferably closely packed (e.g. these have zero separation). Most preferably, the nanostructure according to the invention will be substantially regular in structure.

The maximum height and/or pitch of the nanoridges may vary between different nanoridges, however these will preferably be substantially identical. Similarly, the pitch of each peak may vary between individual peaks on a given nanoridge and those on different nanoridges. However, it is preferred that all peaks on a single nanoridge, more preferably all peaks on all nanoridges, will have substantially the same pitch. In a particularly preferred embodiment of the invention the variation in height along each nanoridge will be constant (i.e. regular) and all nanoridges will be substantially identical in size and structure. A particularly preferred structure is one in which a regular, repeating structure is provided.

At any point along its length, the “height” of a nanoridge according to the invention is the distance measured from the base of the nanoridge to its uppermost surface and includes the height of any peak which may be present at that position. The height of each nanoridge will thus vary (i.e. modulate) along its length due to the presence of one or more peaks. The maximum height of any particular nanoridge is the greatest distance from its base to the highest point on the highest peak.

As used herein in relation to the nanoridges, the term “pitch” is intended to refer to the average distance between the midpoints of adjacent nanoridges and is intended to indicate the periodicity of the structure. In relation to the peaks, the term “pitch” refers to the average distance between the mid-points of adjacent peaks on any one nanoridge.

It is preferred that the maximum height of the nanoridges will be in the range from 50 nm to 800 nm, more especially from 100 nm to 600 nm, preferably from 100 nm to 300 nm, particularly from 180 nm to 200 nm, e.g. about 200 nm. Preferably, the pitch of each nanoridge will be in the range from 50 nm to 800 nm, more especially from 100 nm to 600 nm, preferably from 100 nm to 300 nm, particularly from 180 nm to 200 nm, e.g. about 200 nm. In an especially preferred aspect, the pitch and maximum height of any particular nanoridge (more preferably the pitch and maximum height of essentially all nanoridges in the structure) will be substantially identical, e.g. about 200 nm.

Preferably, the nanoridges will be regularly spaced and be substantially identically oriented. Typically, these will be periodic in structure forming a series of substantially parallel nanoridges. More preferably, adjacent nanoridges will be closely spaced, for example having a separation (i.e. the distance between the bases of neighbouring nanoridges) of less than the wavelength of incident light, more preferably less than half the wavelength of incident light. Yet more preferably, adjacent nanoridges will have zero spacing, i.e. these will be touching at their base.

The peaks on adjacent ridges may be in phase or out of phase with each other, however these will preferably be out of phase, e.g. 180 degrees out of phase. Most preferably these will form a regular array, preferably a substantially hexagonal array. When spaced in a hexagonal pattern, the centres of each peak will typically have a separation of 150 to 300 nm, preferably 200 to 250 nm, e.g. about 231 nm.

Each nanoridge present in the nanostructure according to the invention will contain one or more peaks, preferably a series of peaks. Regarding the peak dimensions, it is preferred that the peak height is from 10 to 90%, preferably from 15 to 50%, of the maximum height of the nanoridge. By “peak height” is meant the ridge modulation depth, i.e. the difference in height between a peak and a neighbouring trough. Preferred peak heights may lie in the range of 10 nm to 200 nm, preferably 20 nm to 100 nm, most especially 30 nm to 50 nm. Where the structure is non-uniform, the peak height may vary between different nanoridges and within the same nanoridge. In an especially preferred aspect, all nanoridges will have substantially identical peak heights.

Although the pitch of the various peaks provided on the nanoridges need not be identical to one another, it is preferred that the peak pitches are substantially identical throughout the nanostructure. Typical values for the pitch of a peak are in the range of from 100 nm to 400 nm, preferably from 150 nm to 350 nm, particularly from 200 nm to 250 nm, e.g. about 231 nm.

It is preferred that the individual nanoridges are identically oriented, e.g. that they run parallel to one another, and that adjacent nanoridges are in contact at their base (i.e. the nanoridges have zero spacing). Regarding a single nanoridge, it is preferred that it is substantially linear, i.e. the nanoridge itself runs in a substantially straight line without any significant bends or angles. Parallel, linear nanoridges are therefore particularly preferred.

The exact shape of the nanoridges is not critical. However, in order to improve the anti-reflection capabilities of the structure, it is preferred that these should be such as to effect a gradient refractive index which causes incident light to progress through the structure with minimal (preferably zero) reflection caused by a sharp change of refractive index. Similar considerations apply to the shape of the peaks provided along the length of each nanoridge. Typically, a smooth refractive index transition may be provided by a nanoridge structure which gradually tapers (i.e. has a reduced cross-sectional area) with increasing structure height, for example this may taper to form a peak. Such a structure forms a porous structure having a plurality of vertical openings or pores. To the extent that the porosity of the structure increases with structure height, the structure has a gradient refractive index thereby resulting in low reflectance over large wavelength bands and a wide range of angles of incident light.

The nanoridges and peaks may form any shape capable of providing a smooth transition of refractive index. Typically these will be angular in shape, for example providing a substantially triangular cross-section in which the top of the ridge is pointed. However, these may be relatively blunt (i.e. flat) or rounded (i.e. curved or smooth). For example, these may be wave-shaped in cross-section. The shape of the ridges and peaks can be chosen independently of one another. It is, however, preferred that all peaks are of substantially the same shape and all ridges are of substantially the same shape (although possibly a different shape to the peaks). In an especially preferred embodiment, the ridges and peaks will be the same shape (although they may have different dimensions).

The bases of the individual nanoridges may be spaced from one another or may be touching. Where these are spaced apart, these will typically be separated by a distance less than or equal to the wavelength of incident light, e.g. visible light. Spaced nanoridges may have a square, rectangular or triangular profile, however these will preferably have a triangular profile in order to maximise anti-reflectance properties. Preferably, the bases of adjacent nanoridges will be touching.

The nanostructures herein described preferably reduce the surface reflectance of the substrate on which these are disposed to less than 2%, preferably less than 1% in the wavelength range from 400 nm to 1000 nm.

The nanostructures of the present invention are, by their nature, capable of being water-repellent and thus self-cleaning due to the water sitting on top of the structure peaks and therefore being raised above an interface much of which is air. When a drop of water rolls over dirt particles on the surface (e.g. following rainfall), these stick to the surface of the water droplet and are then carried away. Preferably the nanostructures of the invention will exhibit a water contact angle of greater than 150°, i.e. they will be superhydrophobic.

The hydrophobic nature of the nanostructures may, however, be enhanced by the use of hydrophobic materials, preferably highly hydrophobic materials. For example, the nanostructures may comprise a hydrophobic material. Alternatively, or in addition, these may be coated with a hydrophobic material. Suitable coating techniques are known in the art, however a preferred method is plasma assisted chemical vapour deposition. By “hydrophobic material” is meant any material which repels water, especially materials with a water contact angle of at least 100°. Examples of such materials are typically fluorocarbons such as PTFE (Teflon®), and materials coated with fluoroalkyl silanes.

In cases where the nanostructures may be subjected to mechanical wear, an optional protective hard coating may also be applied, preferably before the hydrophobic coating.

The nanostructures of the invention may be formed as a surface layer on any suitable substrate, although typically this will be a glass or polymer substrate, for example a transparent polymer film or glass plate. Suitable polymer substrates may comprise polymethyl methacrylate (PMMA) or may be copolymers or blends comprising PMMA or polyethylene terephthalate (PET), polyethylene naphthalate (PEN), cyclic olefin copolymers (COC) and many others. Substrates having disposed thereon a nanostructure as herein described form a further aspect of the invention.

Substrates provided with a nanostructure as herein described may be produced by various methods known in the art, for example etching (e.g. plasma etching), chemical vapour deposition (e.g. plasma enhanced chemical vapour deposition), sol-gel, phase separation, micro-imprinting or moulding, lithography patterning techniques (e.g. holographic lithography, deep UV or e-beam lithography). Any of these techniques may be used to generate a master tool which is then replicated on a roll-to-roll process to produced the desired anti-reflection film.

Holographic lithography is a maskless holographic technique which allows the patterning, by interference, of microscopic feature sizes. The technique involves a periodic or quasi periodic pattern exposed in a photosensitive film by overlapping at least two beams from a laser or other coherent source. The recorded pattern may then be used to form a pattern in an underlying material using well known photolithography techniques. Where necessary, small scale nanostructures produced in this way may be seamlessly stitched together to form larger scale structures using methods such as described in US 2007/0023692.

The nanostructured pattern is thereby formed in a photoresist layer (usually on glass). Nickel electroforming can then be used to replicate this pattern into a metal mould, with further electroplates taken from the previous electroplates. Finally a metal ‘shim’ is formed from one or multiple copies of the initial master structure, which is curved over the surface of a ‘casting drum’ which can be then used to replicate the structure.

Methods which are particularly suitable for the replication of the surface layers and the nanostructures described herein include hot embossing and UV curable resin coating casting which may be carried out in a batch-wise or continuous reel-to-reel manner. An embossed roll is capable of continuously producing a material having a large area of nanostructure.

In a preferred embodiment the substrates in accordance with the invention are produced by a process which involves hot embossing or UV curable resin coating casting.

The nanostructures of the present invention have been found to have anti-reflective and/or self-cleaning properties. A further aspect of the present invention therefore provides the use of the nanostructures, surface layers or optical films of the invention to achieve an anti-reflective and/or self-cleaning effect. It is especially preferred that an anti-reflective effect is retained at high angles of incident light. It is particularly preferred that the nanostructures, surface layers or optical films of the invention achieve both an anti-reflective and a self-cleaning effect.

Due to their self-cleaning and anti-reflective properties, the nanostructures, surface layers and films of the present invention are particularly suitable for use in windows, solar concentrators, flat solar cell modules or other surfaces whose intent is to capture and transmit light. In a further embodiment the invention provides a window, solar concentrator, flat solar cell module or other surfaces whose intent is to capture and transmit light, comprising the nanostructures, surface layers or optical films as described herein.

Due to its anti-reflective properties the structure herein described may also be disposed on the outer surface of image display devices to reduce reflectance and prevent optical interference or image glare caused by external light and thereby enhance the visibility of the image. Examples of such devices include polarizing film for a liquid crystal display (LCD), screens over direct view displays or upon which an image is projected in projection displays, plasma display panels, and optical lenses.

Certain preferred embodiments of the invention will now be described, by way of the following non-limiting examples and with reference to the accompanying drawings in which:

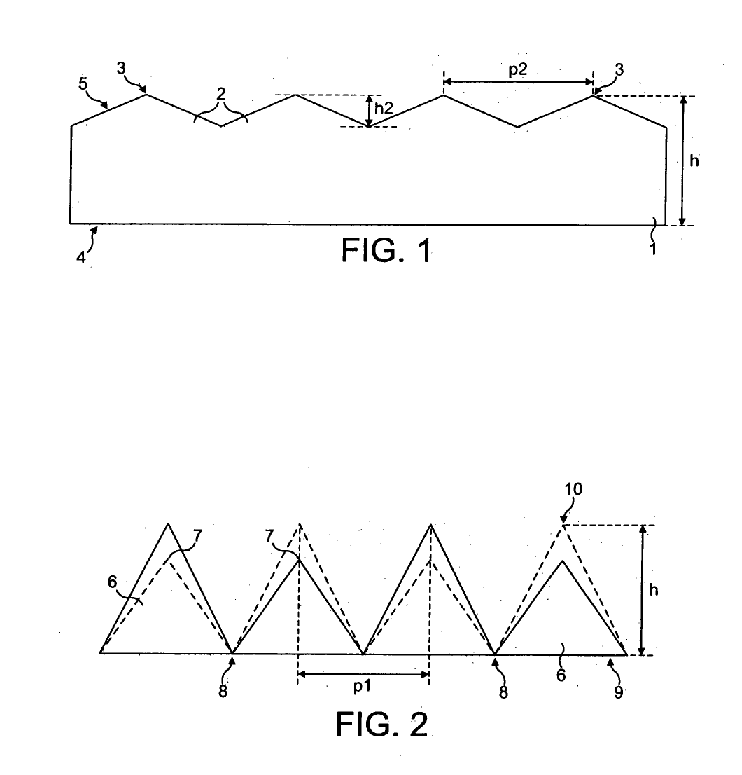

FIG. 1 is a schematic representation of a single nanoridge (longitudinal cross-section) in accordance with an embodiment of the invention;

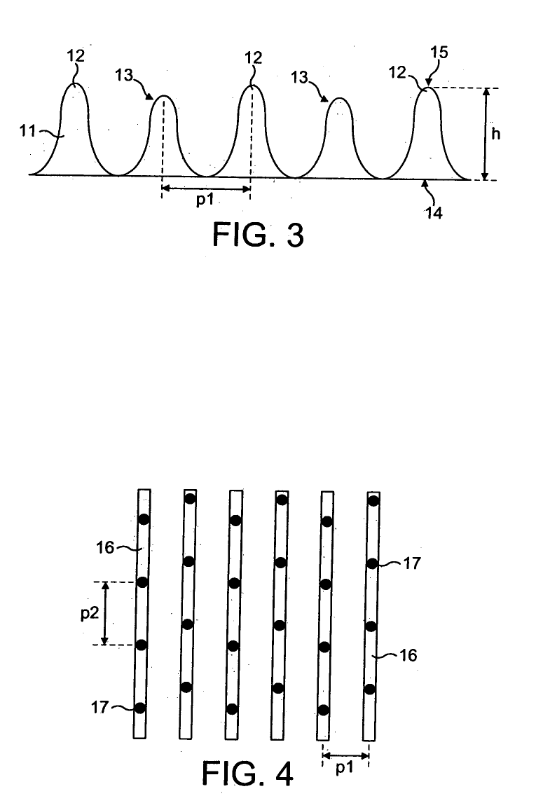

FIGS. 2 and 3 are schematic representations of a series of nanoridges (transverse cross-sections) in accordance with an embodiment of the invention;

FIG. 4 is a schematic representation of a plurality of nanoridges (when viewed from above) in accordance with an embodiment of the invention;

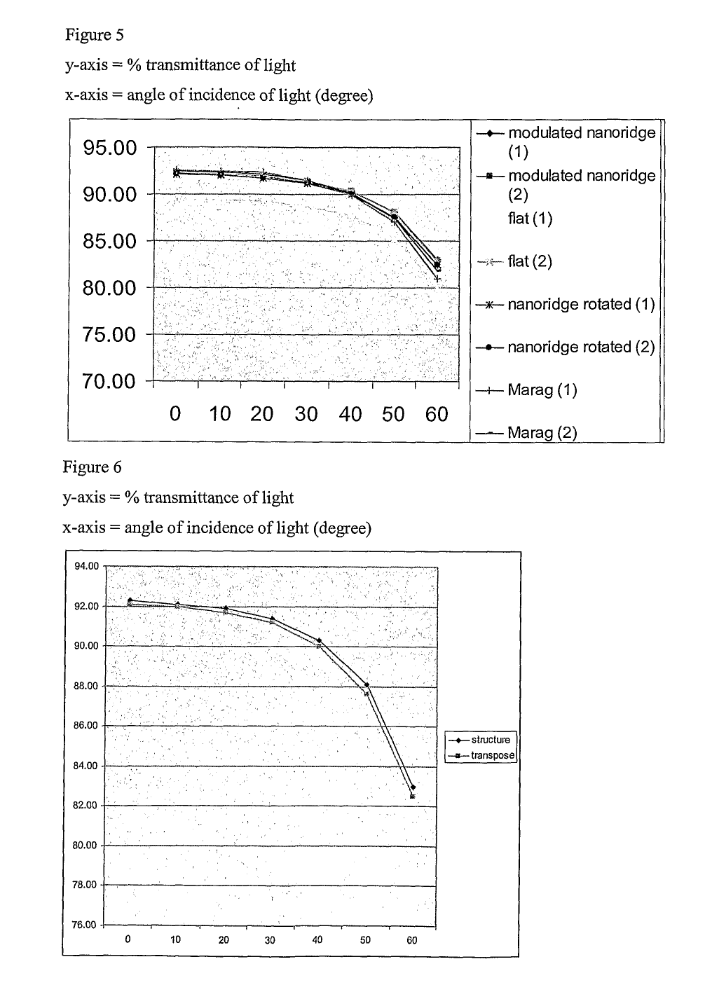

FIG. 5 is a graph showing the % transmission of incident light for various surfaces across a range of angles of incident light (0 to 60°) according to Example 1;

FIG. 6 is a graph showing the reflectance results for a nanostructure in accordance with the invention when the nanoridges are parallel to the incident light direction and transverse to the incident light direction (transpose);

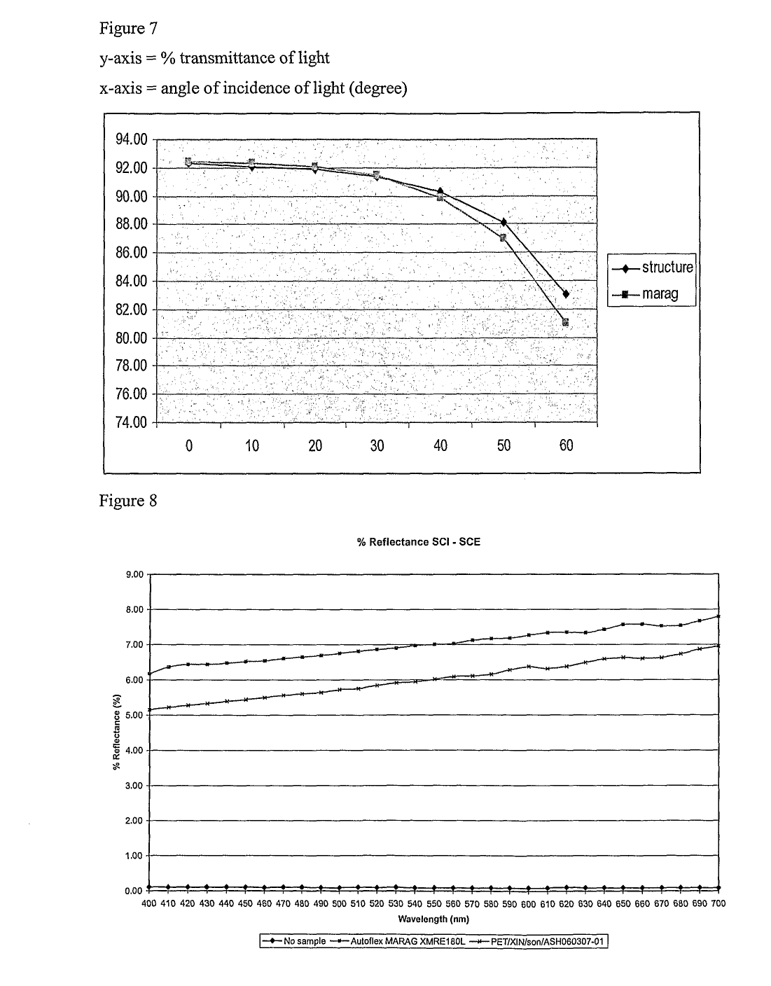

FIG. 7 is a graph which compares the reflectance results from a modulated nanoridge structure according to the invention with those obtained with a MARAG film; and

FIG. 8 is a graph showing the total specular reflectance at multiple wavelengths ranging from 400 nm to 700 nm for a nanostructure according to the invention compared to a MARAG film.

FIG. 1 shows, schematically, a longitudinal cross-section through a section of a single nanoridge which forms part of a nanostructure in accordance with an embodiment of the invention. The nanoridge 1 is provided with a plurality of identical peaks 2 which are angular in profile and which each taper to a tip 3. Each peak has a peak height h2 and a peak pitch p2. At any given point along its length, the height of the nanoridge is the distance measured from the nanoridge base 4 to the upper surface 5 of the nanoridge 1. In FIG. 1 the maximum height h of the nanoridge 1 is the distance from the nanoridge base 4 to the tip 3 of one of the peaks 2. In the embodiment shown, the nanoridge 1 is linear along its length. The series of peaks and troughs formed along the length of the nanoridge provides the desired modulation in the height of the nanoridge.

FIG. 2 shows, schematically, a transverse cross-section through a plurality of identically oriented or parallel nanoridges 6 having a nanoridge pitch p1 (the distance between the mid-points of adjacent nanoridges). Each nanoridge 6 is angular in profile and is provided with a plurality of identical angular peaks 7 (although for the purposes of illustration only the first peak on each nanoridge is shown). In the particular nanostructure shown, adjacent nanoridges 6 are in contact at their base (i.e. there is zero separation) and the peaks 7 on adjacent nanoridges are 180° out of phase. The solid lines illustrate the cross-sectional profile of the nanostructure (comprising alternating peaks 7 and troughs 8). Successive peaks and troughs along the length of each nanoridge 6 provide the desired modulation in nanoridge height. The second peak or trough on each nanoridge is illustrated by way of broken lines. In FIG. 2 the maximum height h of each nanoridge 6 is the distance measured from the nanoridge base 9 to the tip 10 of one of the peaks 7.

FIG. 3 shows, schematically, a transverse cross-section through a plurality of identically oriented or parallel nanoridges 11 having a nanoridge pitch p1. Each nanoridge 11 is wave-like or curved in profile and provided with a plurality of identical smooth or curved peaks 12. Adjacent nanoridges 11 are in contact at their base (i.e. there is zero separation) and the peaks 12 on adjacent nanoridges are 180° out of phase. Successive peaks 12 and troughs 13 along the length of each nanoridge 11 provide the required modulation in nanoridge height. In FIG. 3 the maximum height h of each nanoridge 11 is the distance from the nanoridge base 14 to the tip 15 of one of the peaks 12.

FIG. 4 schematically illustrates a series of identical, parallel nanoridges 16 provided with multiple identical peaks. The highest points 17 of the peaks on adjacent nanoridges 16 are 180° out of phase and form a hexagonal array. The nanoridge pitch p1 is the distance between the mid-point of adjacent nanoridges 16 are represents the periodicity of the nanostructure. The separation between the highest points 17 of adjacent peaks on the same nanoridge 16 is the peak pitch. In a particularly preferred embodiment of the invention in which p1 is 200 nm, p2 is 231 nm.

### EXAMPLE 1

A suitable ridge profile was generated by UV interference patterning in photoresist. Following replication of this structure into a nickel electroformed mould, using hand cast UV curable resin films, this mould was then used to prepare a nano-structured film in accordance with the invention and the reflectance was measured at multiple angles using a collimated white light source, precision angular film holder, calibrated precision photodetector and integrating sphere.

### Results:

The reflective properties of the modulated nanoridge structure were determined in the case where the ridges were oriented parallel to the incident light direction and compared to the following:
1. A flat structure provided on the same base film and formed from the same resin. This resin is Rad-Kote X-6JA-68-A, a commercially available lacquer from Rad-Cure Corporation, 9 Audrey Place, Fairfield, N.J. 07004. This lacquer has been formulated to cure through visible light and its viscosity is 500 cP.
2. The same modulated nanoridge structure, but 90° rotated (i.e. ridges oriented transverse to the direction of incident light).
3. MARAG (Moth Eye Antiglare) film (produced by Autotype).

The results are shown in FIGS. 5-8. From FIG. 6 the marginal improvement in the reflectance results between the correctly oriented ridges (parallel to the incident light direction) and transverse to the incident light direction (transpose) suggests (a) that the nanostructure retains its anisotropy; and (b) that the anisotropy is small.

FIG. 7 compares the results from the modulated nanoridge structure according to the invention with those obtained with the MARAG film. This shows (a) that the differences at zero degrees are very small; and (b) the modulated nanoridge has improved reflectance performance at high angles of incidence, especially in excess of 30 degrees.

Diffuse reflectance at 8 degree measurements was also carried out in a Minolta spectrophotometer. FIG. 8 shows the total specular reflectance at multiple wavelengths ranging from 400 nm to 700 nm for the nanostructure according to the invention compared to the MARAG film. The modulated nanostructure of the invention exhibits a lower reflectance across all wavelengths tested.

### EXAMPLE 2

The modulated nano-structured film prepared in Example 1 was surface treated to provide a hydrophobic coating using a plasma assisted chemical vapour deposition of a few nanometres coating of a highly hydrophobic fluorinated hydrocarbon. Contact angle measurements were carried out and compared to results obtained from a corresponding flat structure. The PG-X ‘pocket’ goniometer from Fibro System AG (Sweden) was used plus its associated software. The system deposits a droplet (here of deionised water) on the surface of the film and the curvature of the droplet is measured using an imaging system. The system is calibrated using spheres of known curvature.

### Results:

The results for the coated modulated nanostructure according to the invention compared to the flat surface provided with the same coating are given in table 1:

TABLE 1
Contact angle measurements

| | | Contact Angle |
|---|---|---|
| Drop | Type of surface | (degrees) |
| 1 | Flat + surface coating | 120.4 |
| 2 | Flat + surface coating | 122.3 |
| 3 | Nanostructure + surface coating | 152.1 |
| 4 | Nanostructure + surface coating | 156.0 |
| 5 | Nanostructure + surface coating | 156.7 |
| 6 | Nanostructure + surface coating | 159.6 |
| 7 | Nanostructure + surface coating | 155.1 |

Contact angle measurements on the nanostructure according to the invention gave values of around 150 to 160 degrees (this is characteristic of a superhydrophobic surface). The same surface coating without the nanostructure gave a contact angle of only 120 to 125 degrees.

1-16. (canceled)

17. A nanostructure comprising a plurality of nanoridges, wherein the height of each nanoridge is modulated to form one or more peaks along the length of each nanoridge, wherein peaks on adjacent nanoridges are out of phase with each other, and wherein each peak has a height in a range of from 10% to 90% of the total height of the nanoridge on which the peak is formed.

18. A nanostructure as claimed in claim 17, wherein each nanoridge has at least one of a total height and a pitch that is less than half the wavelength of incident light.

19. A nanostructure as claimed in claim 17, wherein nanoridges are substantially identically oriented with respect to one another.

20. A nanostructure as claimed in claim 17, wherein said peaks form a substantially hexagonal array.

21. A nanostructure as claimed in claim 17, wherein each nanoridge has a pitch in a range of from 100 nm to 300 ran,

22. A nanostructure as claimed in claim 17, wherein each nanoridge has a total height in a range of from 100 nm to 300 nm.

23. A nanostructure as claimed in claim 17, wherein each peak has a pitch in a range of from 180 nm to 280 nm.

24. A nanostructure as claimed in claim 17, wherein each peak has a height in a range of from 30 nm to 50 nm.

25. A nanostructure as claimed in claim 17, wherein said nanoridge comprises at least one of a hydrophobic material and a hydrophobic coating.

26. A nanostructure as claimed in claim 17, exhibiting a water contact angle of greater than or equal to about 150 degrees.

27. A substrate comprising a nanostructure as claimed in claim 17.

28. A substrate as claimed in claim 27, wherein said nanostructure is formed as a surface layer on a transparent polymer film or glass plate.

29. An optical film comprising the substrate as claimed in claim 28.

30. A method of rendering a surface at least one of anti-reflective and self-cleaning, comprising use of a an optical film as claimed in claim 29.

31. A method of effecting at least one of capture of light and transmission of light, comprising use of an optical film as claimed in claim 29.

32. A method of enhancing visibility of an image displayed on an image display device, the method comprising use of a substrate as claimed in claim 27 on a surface of the image display device.

33. The nanostructure of claim 17, wherein peaks on adjacent nanoridges 180 degrees out of phase with each other.

34. The nanostructure of claim 17, wherein each peak has a pitch of about 231 nm.

35. A light-capturing device or light-transmissive device comprising the substrate of claim 27.

36. A device according to claim 35, selected from the group consisting of windows, solar concentrators, solar cell modules, liquid crystal display devices, plasma display devices, projection display devices, and optical lenses.
